(19) United States
(12) Patent Application Publication
(10) Pub. No.: US 2026/0032059 A1
(43) Pub. Date: Jan. 29, 2026

(54) METHOD FOR IDENTIFYING ARTIFICIAL INTELLIGENCE (AI) UNIT AND COMMUNICATION DEVICE

(71) Applicant: VIVO MOBILE COMMUNICATION CO., LTD., Guangdong (CN)

(72) Inventors: Ang YANG, Dongguan (CN); Peng SUN, Dongguan (CN); Hao WU, Dongguan (CN); Xiang PAN, Dongguan (CN)

(73) Assignee: VIVO MOBILE COMMUNICATION CO., LTD., Guangdong (CN)

(21) Appl. No.: 19/349,054

(22) Filed: Oct. 3, 2025

Related U.S. Application Data
(63) Continuation of application No. PCT/CN2024/085962, filed on Apr. 3, 2024.

(30) Foreign Application Priority Data
Apr. 6, 2023 (CN) 202310364163.7

(51) Int. Cl. H04L 41/16; H04W 24/10

(52) U.S. Cl. CPC H04L 41/16; H04W 24/10

(57) ABSTRACT

This application discloses a method for identifying an AI unit. The method includes: obtaining, by a first communication device, a first identifier of the AI unit, where the AI unit is associated with a second identifier, and sending, by the first communication device, first information of the AI unit to a second communication device, where the first information includes the first identifier of the AI unit.

### CROSS-REFERENCE TO RELATED PATENT APPLICATIONS

The present application is a continuation of PCT Application No. PCT/CN2024/085962, filed on Apr. 3, 2024, which claims priority to Chinese Patent Application No. 202310364163.7, filed with the China National Intellectual Property Administration on Apr. 6, 2023 and entitled “METHOD FOR IDENTIFYING ARTIFICIAL INTELLIGENCE AI UNIT AND COMMUNICATION DEVICE”, the content of both of which is incorporated herein by reference in their entirety.

### TECHNICAL FIELD

This application pertains to the field of communication technologies, and specifically relates to a method for identifying an Artificial Intelligence (AI) unit and a communication device.

### BACKGROUND

Artificial intelligence (AI) is currently widely used in various fields. Integrating artificial intelligence into a wireless communication network to significantly improve technical metrics such as a throughput, a delay, and a user capacity is an important task of future wireless communication networks. An AI module has a plurality of implementations, such as a neural network model, a decision tree, a support vector machine, and a Bayesian classifier.

### SUMMARY

According to a first aspect, a method for identifying an AI unit is provided, including:
obtaining, by a first communication device, a first identifier of the AI unit, where the AI unit is associated with a second identifier; and
sending, by the first communication device, first information of the AI unit to a second communication device, where the first information includes the first identifier of the AI unit.

According to a second aspect, a method for identifying an AI unit is provided, including:
receiving, by a second communication device, first information of the AI unit that is sent by a first communication device, where the first information includes a first identifier of the AI unit, and the AI unit is associated with a second identifier.

According to a third aspect, an apparatus for identifying an AI unit is provided, including:
an obtaining module, configured to obtain a first identifier of the AI unit, where the AI unit is associated with a second identifier; and
a sending module, configured to send first information of the AI unit to a second communication device, where the first information includes the first identifier of the AI unit.

According to a fourth aspect, an apparatus for identifying an AI unit is provided, including:
a receiving module, configured to receive first information of the AI unit that is sent by a first communication device, where the first information includes a first identifier of the AI unit, and the AI unit is associated with a second identifier.

According to a fifth aspect, a first communication device is provided. The first communication device includes a processor and a memory, the memory stores a program or instructions capable of running on the processor, and when the program or the instructions are executed by the processor, the steps of the method according to the first aspect are implemented.

According to a sixth aspect, a first communication device is provided, including a processor and a communication interface. The processor is configured to obtain a first identifier of an AI unit, where the AI unit is associated with a second identifier. The communication interface is configured to send first information of the AI unit to a second communication device, where the first information includes the first identifier of the AI unit.

According to a seventh aspect, a second communication device is provided. The second communication device includes a processor and a memory, the memory stores a program or instructions capable of running on the processor, and when the program or the instructions are executed by the processor, the steps of the method according to the second aspect are implemented.

According to an eighth aspect, a second communication device is provided, including a processor and a communication interface. The communication interface is configured to receive first information that is of an AI unit and that is sent by a first communication device, where the first information includes a first identifier of the AI unit, and the AI unit is associated with a second identifier.

According to a ninth aspect, a readable storage medium is provided. The readable storage medium stores a program or instructions, and when the program or the instructions are executed by a processor, the steps of the method according to the first aspect are implemented, or the steps of the method according to the second aspect are implemented.

According to a tenth aspect, a communication system is provided and includes a first communication device and a second communication device. The first communication device may be configured to perform the steps of the method according to the first aspect, and the second communication device may be configured to perform the steps of the method according to the second aspect.

According to an eleventh aspect, a chip is provided. The chip includes a processor and a communication interface. The communication interface is coupled to the processor, and the processor is configured to run a program or instructions to implement the method according to the first aspect, or to implement the method according to the second aspect.

According to a twelfth aspect, a computer program/program product is provided. The computer program/program product is stored in a storage medium, and the computer program/program product is executed by at least one processor to implement the steps of the method for identifying an AI unit according to the first aspect or the second aspect.

### BRIEF DESCRIPTION OF DRAWINGS

FIG. 1 is a schematic diagram of an architecture of a wireless communication system according to an embodiment of this application;

FIG. 2 is a schematic flowchart 1 of a method for identifying an AI unit according to an embodiment of this application;

FIG. 3 is a schematic diagram 1 of an interaction procedure of a method for identifying an AI unit according to an embodiment of this application;

FIG. 4 is a schematic flowchart 2 of a method for identifying an AI unit according to an embodiment of this application;

FIG. 5 is a schematic structural diagram 1 of an apparatus for identifying an AI unit according to an embodiment of this application;

FIG. 6 is a schematic structural diagram 2 of an apparatus for identifying an AI unit according to an embodiment of this application;

FIG. 7 is a schematic structural diagram of a communication device according to an embodiment of this application;

FIG. 8 is a schematic structural diagram of a terminal according to an embodiment of this application; and

FIG. 9 is a schematic structural diagram of a network side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that, terms used in this way are interchangeable under appropriate circumstances, so that embodiments of this application can be implemented in a sequence other than that illustrated or described herein. Moreover, the terms “first” and “second” typically distinguish between objects of one category rather than limiting a quantity of objects. For example, there can be one or more first objects. In addition, “or” in this application represents at least one of connected objects. For example, “A or B” includes three solutions, that is, solution 1: including A and not including B; solution 2: including B and not including A; and solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that, a technology described in embodiments of this application is not limited to a Long Term Evolution (LTE)/LTE-advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency-Division Multiple Access (SC-FDMA) system, or another system. The terms “system” and “network” are often used interchangeably in the embodiments of this application. The technology described may be used for the systems and radio technologies described above, as well as other systems and radio technologies. The following describes a New Radio (NR) system for illustrative purposes, and NR terms are used in most of the following descriptions. However, these technologies are also applicable to systems such as a 6th Generation (6G) communication system other than the NR system.

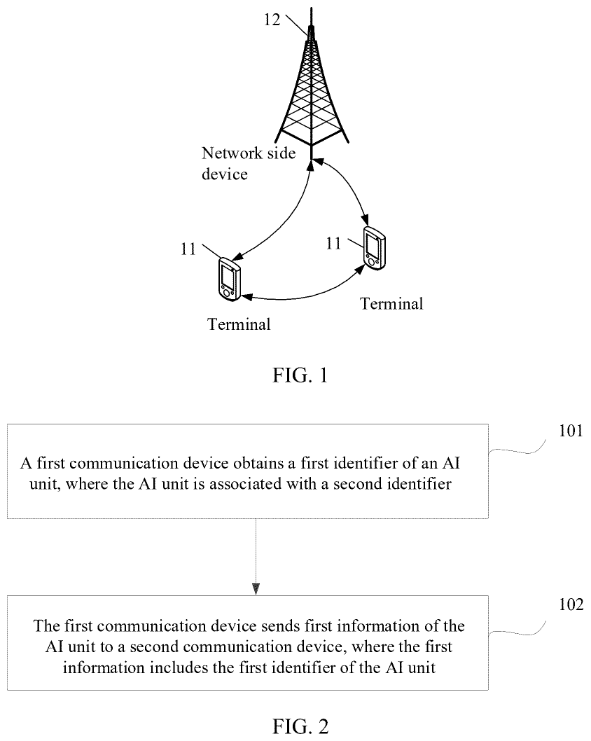

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a flight vehicle, Vehicle User Equipment (VUE), ship-mounted equipment, Pedestrian User Equipment (PUE), a smart home (a home device with a wireless communication function, for example, a refrigerator, a television, a laundry machine, or a furniture), a gaming console, a Personal Computer (PC), a teller machine, a self-service machine, or another terminal side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in this embodiment of this application. The network side device 12 may include an access network device or a core network device. The access network device may also be referred to as a Radio Access Network (RAN) device, a radio access network function, or a radio access network unit. The access network device may include a base station, a Wireless Local Area Network ( ) WLAN) Access Point (AS), a Wireless Fidelity (WiFi) node, and the like. The base station may be referred to as a NodeB (NB), an Evolved NodeB (eNB), the next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another proper term in the field. The base station is not limited to a specific technical term, provided that the same technical effect is achieved. It should be noted that in the embodiments of this application, only a base station in an NR system is used as an example for description, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF or L-NEF), a Binding Support Function (BSF), an Application Function (AF), and the like. It should be noted that in this embodiment of this application, only a core network device in the NR system is used as an example for description, and a specific type of the core network device is not limited.

Related terms in the embodiments of this application are described first.

An AI unit may also be referred to as an AI model, an AI structure, an AI function, an AI feature, a machine learning model, a neural network, a neural network function, a neural network functionality, or the like, or the AI unit may be a processing unit that can implement a specific algorithm, a formula, a processing procedure, a capability, or the like related to AI, or the AI unit may be a processing method, an algorithm, a function, a module, or a unit for a specific dataset, or the AI unit may be a processing method, an algorithm, a function, a module, or a unit that is running on AI-related hardware such as a GPU, an NPU, a TPU, or an ASIC. This is not specifically limited in this application. Optionally, the specific dataset includes input and/or output of the AI unit.

Optionally, an identifier of the AI unit may be an identifier of an AI model, an identifier of an AI structure, an identifier of an AI algorithm, an identifier of a specific dataset associated with the AI unit, or an identifier of an AI-related specific scenario, environment, channel feature, or device, or an identifier of an AI-related function, feature, capability, or module. This is not specifically limited in this application.

Currently, in applications of the AI unit, there are a plurality of terminal manufacturers, a plurality of network device manufacturers, and a plurality of operators. Therefore, it is difficult for such many manufacturers to allocate a concise identifier to one AI unit, and consequently, difficulty of coordination among a plurality of manufacturers is increased, signaling overheads are increased, and difficulty of managing the AI unit is increased.

From another perspective, different procedures require different information for core interaction, and different procedures are in different relationships with corresponding AI units. Therefore, different procedures require different AI unit identifiers. Currently, an AI unit has only one identifier, and cannot meet the foregoing requirement that different procedures correspond to different identifiers.

For example, in a related technology, the AI module has only one identifier, but actually there are a plurality of terminal manufacturers, a plurality of network device manufacturers, and a plurality of operators, and it is difficult to distinguish such many manufacturers by using only one identifier. To distinguish such many manufacturers, identifiers are extremely complex, and consequently, signaling overheads are increased.

Embodiments of this application provide a method for identifying an AI unit and a communication device, which can resolve a problem that identifiers of AI units are complex and signaling overheads are relatively large.

In embodiments of this application, a method for identifying an AI unit is provided. An AI unit is identified from different dimensions, so that, for example, the AI unit has at least two identifiers: a first identifier and a second identifier. Optionally, different identifiers may be used in different procedures, thereby effectively reducing difficulty of coordination among a plurality of manufacturers, reducing signaling overheads, and optimizing management of the AI unit.

A method for identifying an AI unit provided in embodiments of this application is described in detail below with reference to the accompanying drawing by using some embodiments and application scenarios thereof.

FIG. 2 is a schematic flowchart 1 of a method for identifying an AI unit according to an embodiment of this application. As shown in FIG. 2, the method includes steps 101 and 102.

Step 101: A first communication device obtains a first identifier of an AI unit, where the AI unit is associated with a second identifier.

Step 102: The first communication device sends first information of the AI unit to a second communication device, where the first information includes the first identifier of the AI unit.

In embodiments of this application, a first communication device obtains a first identifier of an AI unit, where the AI unit is associated with a second identifier; and the first communication device sends first information of the AI unit to a second communication device, where the first information includes the first identifier of the AI unit. The first identifier may uniquely identify the AI unit, and the second identifier may be used to indicate another procedure, so that complexity of the identifier is reduced, thereby effectively reducing difficulty of coordination among a plurality of manufacturers, reducing signaling overheads, and implementing optimized management of the AI unit.

Optionally, the first communication device may be a generation side/transfer side of the AI unit, for example, a network side device, and the second communication device may be a storage side/use side of the AI unit, for example, a terminal.

Specifically, in transmission/transfer of the AI unit, the AI unit is indicated by using the first identifier, and the first identifier may be used to uniquely identify the AI unit, that is, different AI units have different first identifiers.

The AI unit is associated with the second identifier, that is, the AI unit has the first identifier and the second identifier. The first identifier and the second identifier may be separately used to identify the AI unit in different procedures, for example, the first identifier is used for procedures such as storage/transmission/transfer.

Optionally, the first communication device and the second communication device perform lifecycle management in addition to the procedures such as storage/transmission/transfer by using the second identifier. When the second communication device uses the AI unit, the second communication device selects the AI unit corresponding to the second identifier, or selects, from at least one first identifier associated with the second identifier, an AI unit corresponding to the at least one first identifier.

In the method in this embodiment, a first communication device obtains a first identifier of an AI unit, where the AI unit is associated with a second identifier, that is, the AI unit has the first identifier and the second identifier; and the first communication device sends first information of the AI unit to a second communication device, where the first information includes the first identifier of the AI unit, transfer of the AI unit is indicated by using the first identifier, the second communication device may obtain a unique AI unit based on the first identifier for use, and the second identifier may be used to indicate another procedure, so that complexity of the identifier is reduced, thereby effectively reducing difficulty of coordination among a plurality of manufacturers, reducing signaling overheads, and implementing optimized management of the AI unit.

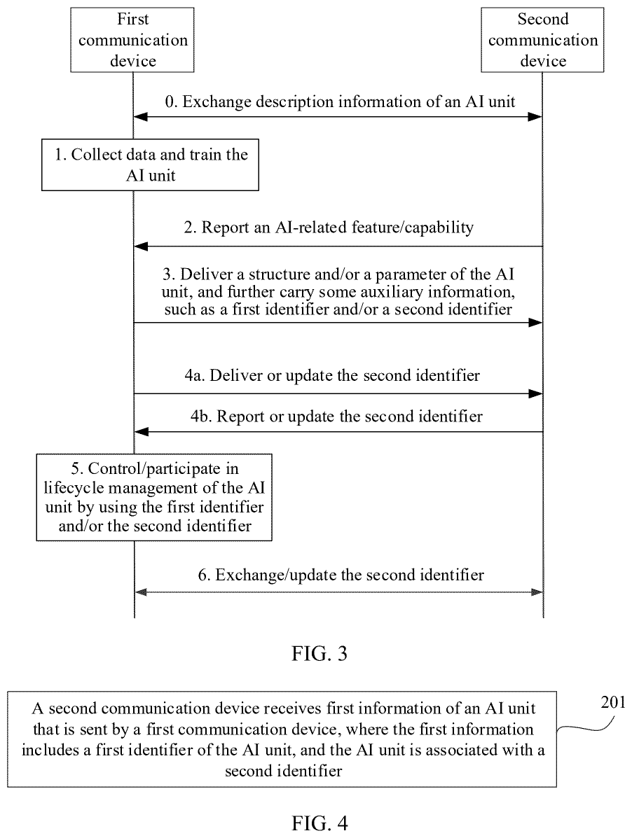

For example, as shown in FIG. 3, the method includes the following steps.

Step 0: The first communication device exchanges description information of the AI unit with the second communication device.

Optionally, a network side exchanges some description information of the AI unit with a terminal, for example, a model structure, complexity, and operation time of the AI unit.

Step 1: The first communication device collects data and trains the AI unit.

Step 2: The second communication device reports an AI-related feature/capability.

Optionally, the terminal reports the AI-related feature/capability (AI/ML-enabled feature) to a network side device.

Step 3: The first communication device delivers a structure and/or a parameter of the AI unit to the second communication device, and further carries some auxiliary information, such as the first identifier and/or the second identifier.

Further, the network side exchanges the second identifier with the terminal or updates the second identifier, including:

Step 4a: The first communication device delivers or updates the second identifier.

Step 4b: The second communication device reports or updates the second identifier.

Step 5: The first communication device controls/participates in lifecycle management of the AI unit by using the first identifier and/or the second identifier.

Step 6: The first communication device exchanges the second identifier with the second communication device or updates the second identifier.

Optionally, the first identifier is used to indicate a first procedure.

The first procedure includes at least one of the following:
storage of the AI unit, transmission of the AI unit, transfer of the AI unit, training of the AI unit, updating of the AI unit, registration of the AI unit, configuration of the AI unit, or identification of the AI unit.

Optionally, the second identifier is used to indicate a second procedure.

The second procedure includes at least one of the following:
activation of the AI unit, deactivation of the AI unit, selection of the AI unit, switching of the AI unit, inference of the AI unit, performance monitoring of the AI unit, performance management of the AI unit, fallback to a non-AI unit, training of the AI unit, updating of the AI unit, registration of the AI unit, configuration of the AI unit, or identification of the AI unit.

Optionally, the first procedure is different from the second procedure.

In the foregoing implementation, the AI unit has the first identifier and the second identifier, and may use different identifiers in different procedures, thereby effectively reducing difficulty of coordination among a plurality of manufacturers, reducing signaling overheads, and optimizing management of the AI unit.

Optionally, the first identifier is associated with at least one of the following:
an AI model, a machine learning model, an AI structure, a neural network, a neural network function, and a neural network functionality;
a processing unit for at least one of an algorithm, a formula, a processing procedure, and a capability related to AI; or
a first object running on at least one AI-related hardware in a Graphics Processing Unit (GPU), an embedded neural network processing unit (Neural-network Processing Unit, NPU), a Tensor Processing Unit (TPU), and an Application Specified Integrated Circuit (ASIC), where the first object includes at least one of the following: a processing method, an algorithm, a function, a module, or a unit.

In some implementations, the AI model includes at least one of a binary (AI) model, an executable (AI) model, a compiled (AI) model (a quantized, compressed, and compiled model), or a private model; and
a source code (AI) model, a non-executable (AI) model, an original (AI) model (a model that is not quantized, compressed, or compiled), and a public model.

Optionally, the second identifier is associated with at least one of the following:
a target dataset associated with the AI unit;
an identifier of a second object associated with the AI unit; or
an identifier of a third object associated with the AI unit; where
the second object includes at least one of the following: a scenario, a cell, a region, a geographical area range, or an access network device; and
the third object includes at least one of the following: a function, a feature, or a configuration.

Optionally, the target dataset includes input data and/or output data of the AI unit, or the target dataset is used to obtain input data and/or output data of the AI unit; and/or
one set in the target dataset includes at least one of the following: at least one piece of input data of the AI unit, at least one piece of output data of the AI unit, or at least one piece of original data, where the original data is used to obtain at least one piece of input data and/or at least one piece of output data of the AI unit.

Optionally, the input data of the AI unit is identical to the output data.

In some embodiments, the input data and the output data may be not distinguished.

Specifically, the AI unit is associated with the target dataset, and the second identifier is associated with the target dataset associated with the AI unit. The target dataset includes the input data and/or the output data of the AI unit, or the input data and/or the output data of the AI unit may be obtained by using the target dataset.

Any dataset included in the target dataset includes at least one piece of input data of the AI unit, at least one piece of output data of the AI unit, and/or at least one piece of original data. At least one piece of input data and/or at least one piece of output data of the AI unit may be obtained through processing by using the original data.

The AI unit is associated with the second object, for example, the AI unit may be used in some scenarios, cells, regions, and geographical area ranges, and the AI unit may be used by some access network devices, or may be used in coverage ranges of some access network devices.

Optionally, the AI unit is obtained after the AI unit is trained based on data collected from the second object; and/or
the AI unit is adapted to the second object, or the AI unit is capable of working normally or achieving normal performance within a coverage range of the second object.

Specifically, the AI unit may be trained by using data collected in a scenario, a cell, a region, a geographic area range, or coverage of an access network device; or the AI unit is adapted to a scenario, a cell, a region, a geographical area range, and/or an access network device (such as a base station). In other words, the AI unit can work normally or achieve normal performance in the foregoing scenario, cell, region, geographical area range, and/or coverage of the access network device.

The AI unit is associated with the third object. For example, the AI unit may be used in some functions, features, and configurations, for example, the AI unit may be used in a specific range such as a signal-to-noise ratio range, cell quality, or a large-scale parameter.

Optionally, a sub-object in the third object includes at least one of the following: a hardware configuration, an antenna configuration, a radio resource configuration, or a radio environment feature.

Specifically, the configuration may include at least one of the following: a hardware configuration, an antenna configuration, or a radio resource configuration, where a feature is, for example, a radio environment feature.

Optionally, the radio environment feature includes, for example, at least one of the following: a speed, a Channel Quality Indicator (CQI), a Rank Indicator (RI), a Layer Indicator (LI), a Signal-to-Noise Ratio (SNR), a Signal to Interference Noise Ratio (SINR), signal power, noise power, interference power, beam quality, cell quality, or a large-scale parameter (such as Doppler shift, Doppler spread, a Doppler average delay, Doppler delay spread, correlation/selectivity of frequency domain/time domain/Doppler domain/delay domain, timing/timing advance, a Line of Sight (LOS), or a Non-Line of Sight (NLOS)).

In the foregoing implementation, the first identifier is associated with a plurality of types of information, and the second identifier is associated with at least one of the following: a target dataset associated with the AI unit, an identifier of the second object associated with the AI unit, or an identifier of the third object associated with the AI unit. Greater flexibility is achieved.

Optionally, one second identifier is mapped to a plurality of first identifiers, that is, one second identifier is associated with a plurality of first identifiers.

In an embodiment, the first communication device performs first processing based on an original AI unit corresponding to the second identifier, to obtain a plurality of AI units. The first identifier of each of the plurality of AI units is different.

Specifically, a specific original AI unit is associated with one second identifier, and first processing is performed based on the original AI unit, such as a specific dataset, a specific AI model, a specific neural network, and a specific AI function/AI feature, to obtain a plurality of AI units, where the AI units respectively correspond to different first identifiers, that is, these AI units are associated with one second identifier.

Optionally, the first processing includes at least one of the following:
performing different compression processing on the original AI unit, where different compression manners or levels correspond to different AI units;
performing different quantization processing on the original AI unit, where different quantization manners or levels correspond to different AI units;
training a plurality of student models by using the original AI unit as a teacher model, where each student model in the plurality of student models corresponds to a different AI unit;
training a plurality of teacher models by using the original AI unit as a student model, where each teacher model in the plurality of teacher models corresponds to a different AI unit;
performing different degrees of data processing on a dataset corresponding to the original AI unit, and performing training based on the dataset obtained after the different degrees of data processing, to obtain a plurality of different AI units, where the data processing includes at least one of the following: data enhancement and data pre-processing; or
when the dataset corresponding to the original AI unit includes a plurality of sub-datasets, combining the sub-datasets in different manners to obtain a plurality of sub-dataset combinations, and performing training based on all the sub-dataset combinations in the plurality of sub-dataset combinations to obtain different AI units.

In some implementations, different compression processing may correspond to different compression levels, and the compression level may also be reflected by a compression rate. For example, a lower compression rate leads to larger storage space occupied by a compressed AI unit.

In some implementations, different compression processing may correspond to different compression manners.

In some implementations, different quantization processing may correspond to different quantization levels, for example, the quantization level may be represented by an integer.

In some implementations, different quantization processing may correspond to different quantization manners.

Optionally, the data enhancement/data pre-processing includes at least one of the following: noise adding, phase adjustment, amplitude adjustment, data truncation, data supplement, and the like. For example, noise of different power is added, and corresponds to different degrees of data enhancement, to obtain different AI units corresponding to different first identifiers.

In some implementations, a specific dataset corresponding to an original AI unit (corresponding to a specific second identifier) includes a plurality of sub-datasets, and the plurality of sub-datasets are combined in different manners to obtain a plurality of combinations, and different AI units are respectively obtained through training based on the plurality of combinations, that is, corresponding to different first identifiers.

For example, subsets at different times are collected in an area. Different combinations of these subsets at different times may be trained to obtain different AI units (corresponding to different first identifiers), but all these AI units are applicable to this area and share a same second identifier.

In the foregoing implementation, one second identifier is mapped to a plurality of first identifiers, that is, one second identifier is associated with a plurality of first identifiers (AI units), so that the AI unit is widely applied and more flexible.

Optionally, the first communication device configures second information associated with a plurality of first identifiers.

When an AI unit corresponding to a target first identifier in the plurality of first identifiers meets the second information, the AI unit corresponding to the target first identifier is capable of being used by the second communication device, and the second information includes at least one of the following: an applicable condition of the AI unit or a Key Performance Indicator (KPI).

Specifically, for a plurality of first identifiers corresponding to one second identifier, the network side device configures second information associated with the plurality of first identifiers. When an AI unit corresponding to a specific target first identifier meets a specific applicable condition/KPI, the terminal uses the AI unit corresponding to the target first identifier.

The applicable condition of the AI unit includes at least one of the following:
a scenario, a cell, a region, a range, and an access network device;
a hardware configuration, an antenna configuration, and a radio resource configuration; or
a radio environment feature.

For example, a specific AI unit may be used in some scenarios, cells, regions, and ranges specified in an applicable condition of the AI unit, and the second communication device performs some operations by using the AI unit.

For example, a specific AI unit may be applicable to some hardware configurations, antenna configurations, radio resource configurations, or the like, and the second communication device performs some operations by using the AI unit.

For example, description information of the AI unit may include information such as an applicable condition of the AI unit and a KPI.

Optionally, one AI unit is associated with a plurality of second identifiers.

Specifically, one first identifier may be mapped to a plurality of second identifiers, that is, one first identifier may be associated with a plurality of second identifiers.

In transmission/transfer of the AI unit, the AI unit is indicated by using the first identifier (one AI unit corresponds to one first identifier), and one AI unit is associated with a plurality of second identifiers.

For example, the second identifier is related to a region, that is, one AI unit may work normally in a plurality of regions. When the network side device indicates first identifiers of different regions, the first identifiers actually point to a same AI unit.

In some embodiments, the network side device and a terminal side perform lifecycle management (except storage/transmission/transfer) by using the second identifier. The terminal selects an AI unit corresponding to the second identifier, or selects, from AI units corresponding to at least one first identifier associated with the second identifier, an AI unit corresponding to the at least one first identifier.

In the foregoing implementation, one first identifier may be mapped to a plurality of second identifiers, that is, one AI unit may be associated with a plurality of second identifiers, so that the AI unit is widely applied and is more flexible.

Optionally, the first information is used to instruct the second communication device to update the AI unit corresponding to the first identifier; or
the method further includes:
updating, by the first communication device, the AI unit corresponding to the first identifier.

Specifically, the network side device sends the AI unit, and simultaneously indicates/carries the first identifier, for example, indicates/carries the first identifier by using the first information. In this case, the AI unit corresponding to the first identifier is updated, that is, the second communication device updates, based on an indication of the first information, the AI unit corresponding to the first identifier.

Alternatively, the network side device may update the AI unit.

Optionally, the first information includes a parameter of the AI unit, and the first information is used to instruct to update the parameter of the AI unit corresponding to the first identifier; and
the updating, by the first communication device, the AI unit corresponding to the first identifier includes:
updating, by the first communication device, the parameter of the AI unit corresponding to the first identifier.

Specifically, for example, updating the parameter of the AI unit is as follows: A structure, an architecture, or running logic of the AI unit remains unchanged, and only a model parameter or a model coefficient changes.

When the first information sent by the network side device includes only the parameter of the AI unit, the first information is used to instruct to update the parameter of the AI unit corresponding to the first identifier.

Optionally, when the AI unit is updated, the second identifier associated with the AI unit remains unchanged, and/or the first identifier of the updated AI unit is different from the first identifier of the unupdated AI unit.

In the foregoing implementation, updating of the AI unit may be indicated by using the first information, and this solution is simple. The first identifier of the updated AI unit is different from the first identifier of the unupdated AI unit, that is, the AI unit may be uniquely identified by using the first identifier. However, the second identifier of the updated AI unit is identical to the second identifier of the unupdated AI unit, and some procedures may still be indicated by using a same second identifier.

Optionally, when the second communication device uses the AI unit, the first communication device indicates or carries third information when the first communication device performs at least one of data collection configuration, measurement resource configuration, or reporting resource configuration.

Optionally, when the second communication device uses the AI unit, the first communication device receives the third information carried when the second communication device reports collected data, where the collected data is data that is of a second object corresponding to the third information and that is collected by the second communication device, and/or the collected data is data that is of a sub-object in a third object corresponding to the third information and that is collected by the second communication device, the second object includes at least one of the following: a scenario, a cell, a region, a geographical area range, or an access network device, and the sub-object in the third object includes at least one of the following: a hardware configuration, an antenna configuration, a radio resource configuration, or a radio environment feature.

The third information includes the second identifier and/or an applicable condition of the AI unit.

Specifically, when performing at least one of data collection configuration, measurement resource configuration, or reporting resource configuration, the network side device indicates or carries the third information, such as the second identifier and/or an applicable condition; or
when the first communication device uses the AI unit, the first communication device collects data of a second object corresponding to the third information, and/or collects data of the sub-object in the third object corresponding to the third information, and the first communication device carries the third information when reporting the collected data.

For example, the first communication device collects data in a scenario, a cell, a region, or a geographical area range corresponding to the second identifier.

Optionally, the applicable condition may be associated with the second identifier of the AI unit.

For example, when configuring a measurement resource for the terminal, the network side device indicates or carries the third information by using signaling for sending configuration information of the measurement resource.

Optionally, when the second communication device uses the AI unit, the first information further includes an applicable condition of the AI unit.

Optionally, when the second communication device uses the AI unit, the first communication device indicates, to the second communication device by using second signaling, an applicable condition of the AI unit associated with the second identifier.

Optionally, the first communication device receives an applicable condition of the AI unit that is reported by the second communication device based on the second identifier.

Optionally, the first communication device modifies the applicable condition based on the second identifier.

Optionally, the first communication device updates the applicable condition based on the second identifier.

Specifically, the network side device may exchange the applicable condition with the terminal based on the second identifier.

The network side device may carry the applicable condition of the AI unit when transmitting/transferring the AI unit, that is, carry the applicable condition by using the first information.

The network side device may indicate, by using the second signaling, the applicable condition of the AI unit associated with the second identifier, for example, the second signaling is different from signaling for sending the first information.

The terminal may report, to the network side device, the applicable condition of the AI unit associated with the second identifier.

In some embodiments, both the terminal and the network side device may exchange, modify, and update the applicable condition based on the second identifier.

The applicable condition of the AI unit is associated with the second identifier. For example, if one second identifier is associated with one AI unit, the applicable condition of the AI unit is only for the AI unit; and if one second identifier is associated with a plurality of AI units, the applicable condition of the AI unit may be for the plurality of AI units, that is, applicable to all the plurality of AI units.

Optionally, lifecycle management of the AI unit is mainly performed based on the second identifier. In other words, the network side device and the terminal side perform lifecycle management in addition to a procedure such as storage/transmission/transfer by using the second identifier. The terminal selects the AI unit corresponding to the second identifier, or selects, from AI units corresponding to at least one first identifier associated with the second identifier, an AI unit corresponding to the at least one first identifier and uses the AI unit.

Optionally, when a current condition does not meet the applicable condition of the AI unit, the first communication device performs second processing, where the second processing includes at least one of the following: switching of the AI unit, deactivation of the AI unit, selection of a new AI unit, performance monitoring, performance monitoring reporting, or data collection.

Optionally, when an applicable condition of a target AI unit meets the current condition, the first communication device performs third processing, where the third processing includes at least one of the following: switching of the AI unit, activation of the target AI unit, performance monitoring, performance monitoring reporting, or data collection.

Specifically, based on the applicable condition, some lifecycle management may be automatically triggered and managed, for example:
a) If a current condition does not meet an applicable condition of a current AI unit, for example, a scenario or a cell in which the first communication device is currently located does not meet the applicable condition of the current AI unit, a procedure such as switching the AI unit (to another AI unit), deactivating (deactivating the current AI unit), selecting a new AI unit, performance monitoring, performance monitoring reporting, or data collection is automatically triggered.
b) There is another AI unit that meets the current condition, that is, if there is another AI unit whose applicable condition matches the current condition to a greater extent, a procedure such as switching of the AI unit (to the another AI unit), activating (activating the another AI unit), performance monitoring, performance monitoring reporting, or data collection is automatically triggered.

In the foregoing implementation, the applicable condition of the AI unit is set, so that precision of use of the AI unit is improved, and reliability of a communication system is improved.

FIG. 4 is a schematic flowchart 2 of a method for identifying an AI unit according to an embodiment of this application. As shown in FIG. 4, the method includes the following steps.

Step 201: A second communication device receives first information that is of an AI unit and that is sent by a first communication device, where the first information includes a first identifier of the AI unit, and the AI unit is associated with a second identifier.

Optionally, the first identifier is used to indicate a first procedure.

The first procedure includes at least one of the following:
storage of the AI unit, transmission of the AI unit, transfer of the AI unit, training of the AI unit, updating of the AI unit, registration of the AI unit, configuration of the AI unit, or identification of the AI unit.

Optionally, the second identifier is used to indicate a second procedure.

The second procedure includes at least one of the following:
activation of the AI unit, deactivation of the AI unit, selection of the AI unit, switching of the AI unit, inference of the AI unit, performance monitoring of the AI unit, performance management of the AI unit, fallback to a non-AI unit, training of the AI unit, updating of the AI unit, registration of the AI unit, configuration of the AI unit, or identification of the AI unit.

Optionally, the first identifier is associated with at least one of the following:
an AI model, a machine learning model, an AI structure, a neural network, a neural network function, and a neural network functionality;
a processing unit for at least one of an algorithm, a formula, a processing procedure, and a capability related to AI; or
a first object running on at least one AI-related hardware in a graphics processing unit GPU, an embedded neural network processing unit NPU, a tensor processing unit TPU, and an application-specific integrated circuit ASIC, where the first object includes at least one of the following: a processing method, an algorithm, a function, a module, or a unit.

Optionally, the second identifier is associated with at least one of the following:
a target dataset associated with the AI unit;
an identifier of a second object associated with the AI unit; or
an identifier of a third object associated with the AI unit; where
the second object includes at least one of the following: a scenario, a cell, a region, a geographical area range, or an access network device; and
the third object includes at least one of the following: a function, a feature, or a configuration.

Optionally, the target dataset includes input data and/or output data of the AI unit, or the target dataset is used to obtain input data and/or output data of the AI unit; and/or
one set in the target dataset includes at least one of the following: at least one piece of input data of the AI unit, at least one piece of output data of the AI unit, or at least one piece of original data, where the original data is used to obtain at least one piece of input data and/or at least one piece of output data of the AI unit.

Optionally, the input data of the AI unit is identical to the output data.

Optionally, the AI unit is obtained after the AI unit is trained based on data collected from the second object; and/or
the AI unit is adapted to the second object, or the AI unit is capable of working normally or achieving normal performance within a coverage range of the second object.

Optionally, a sub-object in the third object includes at least one of the following: a hardware configuration, an antenna configuration, a radio resource configuration, or a radio environment feature.

Optionally, the first information further includes the second identifier of the AI unit; or
the method further includes:
receiving, by the second communication device, the second identifier sent by the first communication device by using first signaling, where the first signaling is different from signaling for sending description information of the AI unit.

Optionally, the first information further includes the description information of the AI unit, and the description information of the AI unit includes the second identifier of the AI unit.

Optionally, one second identifier is associated with a plurality of AI units, and the first identifier of each of the plurality of AI units is different.

Optionally, the plurality of AI units are obtained by the first communication device by performing first processing based on an original AI unit corresponding to the second identifier.

The first processing includes at least one of the following:
performing different compression processing on the original AI unit, where different compression manners or levels correspond to different AI units;
performing different quantization processing on the original AI unit, where different quantization manners or levels correspond to different AI units;
training a plurality of student models by using the original AI unit as a teacher model, where each student model in the plurality of student models corresponds to a different AI unit;
training a plurality of teacher models by using the original AI unit as a student model, where each teacher model in the plurality of teacher models corresponds to a different AI unit;
performing different degrees of data processing on a dataset corresponding to the original AI unit, and performing training based on the dataset obtained after the different degrees of data processing, to obtain a plurality of different AI units, where the data processing includes at least one of the following: data enhancement or data pre-processing; or
when the dataset corresponding to the original AI unit includes a plurality of sub-datasets, combining the sub-datasets in different manners to obtain a plurality of sub-dataset combinations, and performing training based on all the sub-dataset combinations in the plurality of sub-dataset combinations to obtain different AI units.

Optionally, the method further includes:
when an AI unit corresponding to a target first identifier in the plurality of first identifiers meets the second information, using, by the second communication device, the AI unit corresponding to the target first identifier, where the second information includes at least one of the following: an applicable condition of the AI unit and a key performance indicator KPI, and the second information is configured by the first communication device.

Optionally, one AI unit is associated with a plurality of second identifiers.

Optionally, the first information is used to instruct the second communication device to update the AI unit corresponding to the first identifier; and
the method further includes:
updating, by the second communication device, the AI unit corresponding to the first identifier.

Optionally, the first information includes a parameter of the AI unit, and the first information is used to instruct to update a parameter of the AI unit corresponding to the first identifier; and
the updating, by the second communication device, the AI unit corresponding to the first identifier includes:
updating, by the second communication device, the parameter of the AI unit corresponding to the first identifier.

Optionally, when the AI unit is updated, the second identifier associated with the AI unit remains unchanged, and/or the first identifier of the updated AI unit is different from the first identifier of the unupdated AI unit.

Optionally, the method further includes:
when the second communication device uses the AI unit, receiving, by the second communication device, third information sent by the first communication device, where the third information is sent when the first communication device performs at least one of data collection configuration, measurement resource configuration, and reporting resource configuration; or
when the second communication device uses the AI unit, carrying, by the second communication device, the third information when reporting collected data, where the collected data is data that is of a second object corresponding to the third information and that is collected by the second communication device, and/or the collected data is data that is of a sub-object in a third object corresponding to the third information and that is collected by the second communication device, the second object includes at least one of the following: a scenario, a cell, a region, a geographical area range, and an access network device, and the sub-object in
the third object includes at least one of the following: a hardware configuration, an antenna configuration, a radio resource configuration, and a radio environment feature; where the third information includes the second identifier and/or an applicable condition of the AI unit.

Optionally, the method further includes at least one of the following:
when the second communication device uses the AI unit, the first information further includes an applicable condition of the AI unit;
when the second communication device uses the AI unit, receiving, by the second communication device, an applicable condition that is of the AI unit associated with the second identifier and that is sent by the first communication device by using second signaling;
reporting, by the second communication device, the applicable condition of the AI unit to the first communication device based on the second identifier;
modifying, by the second communication device, the applicable condition based on the second identifier; and
updating, by the second communication device, the applicable condition based on the second identifier.

Optionally, the applicable condition of the AI unit includes at least one of the following:
a scenario, a cell, a region, a range, and an access network device;
a hardware configuration, an antenna configuration, and a radio resource configuration; and
a radio environment feature.

A specific implementation process and technical effects of the method in this embodiment are the same as those in the method embodiment on the first communication device side. For details, reference may be made to the detailed descriptions in the method embodiment on the first communication device side. Details are not described herein again.

The method for identifying an AI unit provided in the embodiments of this application may be performed by an apparatus for identifying an AI unit. In the embodiments of this application, an example in which an apparatus for identifying an AI unit performs the method for identifying an AI unit is used to describe the apparatus for identifying an AI unit provided in the embodiments of this application.

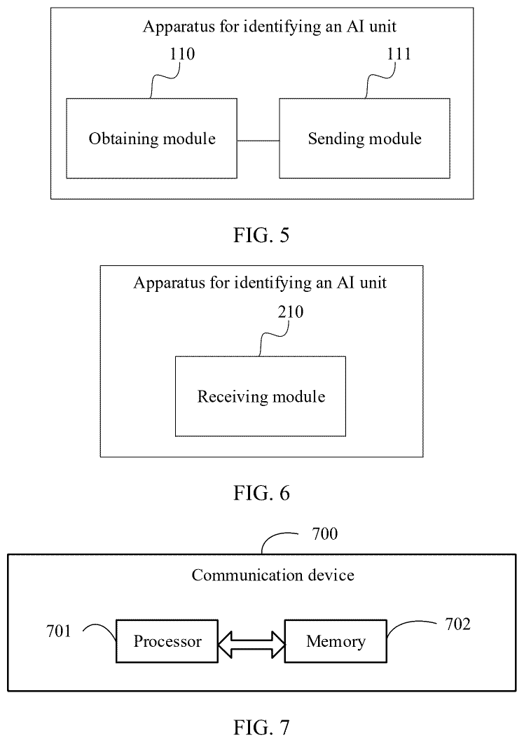

FIG. 5 is a schematic structural diagram 1 of an apparatus for identifying an AI unit according to this application. As shown in FIG. 5, the apparatus for identifying an AI unit provided in this embodiment includes:
an obtaining module 110, configured to obtain a first identifier of an AI unit, where the AI unit is associated with a second identifier; and
a sending module 111, configured to send first information of the AI unit to a second communication device, where the first information includes the first identifier of the AI unit.

Optionally, the first identifier is used to indicate a first procedure.

The first procedure includes at least one of the following:
storage of the AI unit, transmission of the AI unit, transfer of the AI unit, training of the AI unit, updating of the AI unit, registration of the AI unit, configuration of the AI unit, and identification of the AI unit.

Optionally, the second identifier is used to indicate a second procedure.

The second procedure includes at least one of the following:
activation of the AI unit, deactivation of the AI unit, selection of the AI unit, switching of the AI unit, inference of the AI unit, performance monitoring of the AI unit, performance management of the AI unit, fallback to a non-AI unit, training of the AI unit, updating of the AI unit, registration of the AI unit, configuration of the AI unit, and identification of the AI unit.

Optionally, the first identifier is associated with at least one of the following:
an AI model, a machine learning model, an AI structure, a neural network, a neural network function, and a neural network functionality;
a processing unit for at least one of an algorithm, a formula, a processing procedure, and a capability related to AI; and
a first object running on at least one AI-related hardware in a graphics processing unit GPU, an embedded neural network processing unit NPU, a tensor processing unit TPU, and an application-specific integrated circuit ASIC, where the first object includes at least one of the following: a processing method, an algorithm, a function, a module, or a unit.

Optionally, the second identifier is associated with at least one of the following:
a target dataset associated with the AI unit;
an identifier of a second object associated with the AI unit; and
an identifier of a third object associated with the AI unit; where
the second object includes at least one of the following: a scenario, a cell, a region, a geographical area range, and an access network device; and
the third object includes at least one of the following: a function, a feature, and a configuration.

Optionally, the target dataset includes input data and/or output data of the AI unit, or the target dataset is used to obtain input data and/or output data of the AI unit; and/or
one set in the target dataset includes at least one of the following: at least one piece of input data of the AI unit, at least one piece of output data of the AI unit, and at least one piece of original data, where the original data is used to obtain at least one piece of input data and/or at least one piece of output data of the AI unit.

Optionally, the input data of the AI unit is identical to the output data.

Optionally, the AI unit is obtained after the AI unit is trained based on data collected from the second object; and/or
the AI unit is adapted to the second object, or the AI unit is capable of working normally or achieving normal performance within a coverage range of the second object.

Optionally, a sub-object in the third object includes at least one of the following: a hardware configuration, an antenna configuration, a radio resource configuration, and a radio environment feature.

Optionally, the first communication device is a network side device, and the second communication device is a terminal.

Optionally, when the second communication device uses the AI unit, the first communication device performs lifecycle management of the second procedure for the AI unit by using the second identifier of the AI unit.

Optionally, the first information further includes the second identifier of the AI unit; or
the sending module 111 is further configured to:
send the second identifier to the second communication device by using first signaling, where the first signaling is different from signaling for sending description information of the AI unit.

Optionally, the first information further includes the description information of the AI unit, and the description information of the AI unit includes the second identifier of the AI unit.

Optionally, the apparatus further includes:
a processing module, configured to perform first processing first processing based on an original AI unit corresponding to the second identifier, to obtain a plurality of AI units, where the first identifier of each of the plurality of AI units is different.

Optionally, the first processing includes at least one of the following:
performing different compression processing on the original AI unit, where different compression manners or levels correspond to different AI units;
performing different quantization processing on the original AI unit, where different quantization manners or levels correspond to different AI units;
training a plurality of student models by using the original AI unit as a teacher model, where each student model in the plurality of student models corresponds to a different AI unit;
training a plurality of teacher models by using the original AI unit as a student model, where each teacher model in the plurality of teacher models corresponds to a different AI unit;
performing different degrees of data processing on a dataset corresponding to the original AI unit, and performing training based on the dataset obtained after the different degrees of data processing, to obtain a plurality of different AI units, where the data processing includes at least one of the following: data enhancement and data pre-processing; and
when the dataset corresponding to the original AI unit includes a plurality of sub-datasets, combining the sub-datasets in different manners to obtain a plurality of sub-dataset combinations, and performing training based on all the sub-dataset combinations in the plurality of sub-dataset combinations to obtain different AI units.

Optionally, the processing module is further configured to:
configure second information associated with a plurality of first identifiers; where
when an AI unit corresponding to a target first identifier in the plurality of first identifiers meets the second information, the AI unit corresponding to the target first identifier is capable of being used by the second communication device, and the second information includes at least one of the following: an applicable condition and a key performance indicator KPI.

Optionally, the AI unit is associated with a plurality of second identifiers.

Optionally, the first information is used to instruct the second communication device to update the AI unit corresponding to the first identifier; or
the processing module is further configured to:
update the AI unit corresponding to the first identifier.

Optionally, the first information includes a parameter of the AI unit, and the first information is used to instruct to update a parameter of the AI unit corresponding to the first identifier; and
the processing module is specifically configured to:
update the parameter of the AI unit corresponding to the first identifier.

Optionally, when the AI unit is updated, the second identifier associated with the AI unit remains unchanged, and/or the first identifier of the updated AI unit is different from the first identifier of the unupdated AI unit.

Optionally, the sending module 111 is further configured to:
when the second communication device uses the AI unit, indicate or carry third information when the first communication device performs at least one of data collection configuration, measurement resource configuration, and reporting resource configuration.

The obtaining module 110 is further configured to:
when the second communication device uses the AI unit, receive the third information carried when the second communication device reports collected data, where the collected data is data that is of a second object corresponding to the third information and that is collected by the second communication device, and/or the collected data is data that is of a sub-object in a third object corresponding to the third information and that is collected by the second communication device, the second object includes at least one of the following: a scenario, a cell, a region, a geographical area range, and an access network device, and the sub-object in the third object includes at least one of the following: a hardware configuration, an antenna configuration, a radio resource configuration, and a radio environment feature; where
the third information includes the second identifier and/or an applicable condition of the AI unit.

Optionally, when the second communication device uses the AI unit, the first information further includes an applicable condition of the AI unit.

Optionally, when the second communication device uses the AI unit, the sending module 111 is further configured to indicate, to the second communication device by using second signaling, an applicable condition of the AI unit associated with the second identifier.

Optionally, when the second communication device uses the AI unit, the obtaining module 110 is further configured to receive the applicable condition of the AI unit that is reported by the second communication device based on the second identifier.

Optionally, when the second communication device uses the AI unit, the processing module is further configured to perform at least one of the following:
modifying the applicable condition based on the second identifier; and
updating the applicable condition based on the second identifier.

Optionally, the applicable condition of the AI unit includes at least one of the following:
a scenario, a cell, a region, a range, and an access network device;
a hardware configuration, an antenna configuration, and a radio resource configuration; and
a radio environment feature.

Optionally, the processing module is further configured to perform at least one of the following:
when a current condition does not meet the applicable condition of the AI unit, performing second processing, where the second processing includes at least one of the following: switching of the AI unit, deactivation of the AI unit, selection of a new AI unit, performance monitoring, performance monitoring reporting, and data collection; and
when an applicable condition of a target AI unit meets the current condition, performing third processing, where the third processing includes at least one of the following: switching of the AI unit, activation of the target AI unit, performance monitoring, performance monitoring reporting, and data collection.

The apparatus in this embodiment may be configured to perform the method according to any one of the foregoing method embodiments on the first communication device side. A specific implementation process and technical effects of the apparatus in this embodiment are the same as those in the method embodiments on the first communication device side. For details, reference may be made to the detailed descriptions in the method embodiments on the first communication device side. Details are not described herein.

FIG. 6 is a schematic structural diagram 2 of an apparatus for identifying an AI unit according to this application. As shown in FIG. 6, the apparatus for identifying an AI unit provided in this embodiment includes:
a receiving module 210, configured to receive first information that is of an AI unit and that is sent by a first communication device, where the first information includes a first identifier of the AI unit, and the AI unit is associated with a second identifier.

Optionally, the first identifier is used to indicate a first procedure.

The first procedure includes at least one of the following:
storage of the AI unit, transmission of the AI unit, transfer of the AI unit, training of the AI unit, updating of the AI unit, registration of the AI unit, configuration of the AI unit, and identification of the AI unit.

Optionally, the second identifier is used to indicate a second procedure.

The second procedure includes at least one of the following:
activation of the AI unit, deactivation of the AI unit, selection of the AI unit, switching of the AI unit, inference of the AI unit, performance monitoring of the AI unit, performance management of the AI unit, fallback to a non-AI unit, training of the AI unit, updating of the AI unit, registration of the AI unit, configuration of the AI unit, and identification of the AI unit.

Optionally, the first identifier is associated with at least one of the following:
an AI model, a machine learning model, an AI structure, a neural network, a neural network function, and a neural network functionality;
a processing unit for at least one of an algorithm, a formula, a processing procedure, and a capability related to AI; and
a first object running on at least one AI-related hardware in a graphics processing unit GPU, an embedded neural network processing unit NPU, a tensor processing unit TPU, and an application-specific integrated circuit ASIC, where the first object includes at least one of the following: a processing method, an algorithm, a function, a module, or a unit.

Optionally, the second identifier is associated with at least one of the following:
a target dataset associated with the AI unit;
an identifier of a second object associated with the AI unit; and
an identifier of a third object associated with the AI unit; where
the second object includes at least one of the following: a scenario, a cell, a region, a geographical area range, and an access network device; and
the third object includes at least one of the following: a function, a feature, and a configuration.

Optionally, the target dataset includes input data and/or output data of the AI unit, or the target dataset is used to obtain input data and/or output data of the AI unit; and/or
one set in the target dataset includes at least one of the following: at least one piece of input data of the AI unit, at least one piece of output data of the AI unit, and at least one piece of original data, where the original data is used to obtain at least one piece of input data and/or at least one piece of output data of the AI unit.

Optionally, the input data of the AI unit is identical to the output data.

Optionally, the AI unit is obtained after the AI unit is trained based on data collected from the second object; and/or
the AI unit is adapted to the second object, or the AI unit is capable of working normally or achieving normal performance within a coverage range of the second object.

Optionally, a sub-object in the third object includes at least one of the following: a hardware configuration, an antenna configuration, a radio resource configuration, and a radio environment feature.

Optionally, the first information further includes the second identifier of the AI unit; or
the second communication device receives the second identifier sent by the first communication device by using first signaling, where the first signaling is different from signaling for sending description information of the AI unit.

Optionally, the first information further includes the description information of the AI unit, and the description information of the AI unit includes the second identifier of the AI unit.

Optionally, one second identifier is associated with a plurality of AI units, and the first identifier of each of the plurality of AI units is different.

Optionally, the apparatus further includes:
a processing module, configured to: when an AI unit corresponding to a target first identifier in the plurality of first identifiers meets the second information, use the AI unit corresponding to the target first identifier, where the second information includes at least one of the following: an applicable condition of the AI unit and a key performance indicator KPI, and the second information is configured by the first communication device.

Optionally, one AI unit is associated with a plurality of second identifiers.

Optionally, the first information is used to instruct the second communication device to update the AI unit corresponding to the first identifier; and
the processing module is further configured to:
update the AI unit corresponding to the first identifier.

Optionally, the first information includes a parameter of the AI unit, and the first information is used to instruct to update a parameter of the AI unit corresponding to the first identifier; and the processing module is specifically configured to:
update the parameter of the AI unit corresponding to the first identifier.

Optionally, when the AI unit is updated, the second identifier associated with the AI unit remains unchanged, and/or the first identifier of the updated AI unit is different from the first identifier of the unupdated AI unit.

Optionally, the receiving module 210 is further configured to:
when the second communication device uses the AI unit, receive third information sent by the first communication device, where the third information is sent when the first communication device performs at least one of data collection configuration, measurement resource configuration, and reporting resource configuration; or
the apparatus further includes:
a sending module, configured to: when the second communication device uses the AI unit, carry the third information when reporting collected data, where the collected data is data that is of a second object corresponding to the third information and that is collected by the second communication device, and/or the collected data is data that is of a sub-object in a third object corresponding to the third information and that is collected by the second communication device, the second object includes at least one of the following: a scenario, a cell, a region, a geographical area range, or an access network device, and the sub-object in the third object includes at least one of the following: a hardware configuration, an antenna configuration, a radio resource configuration, or a radio environment feature; where
the third information includes the second identifier and/or an applicable condition of the AI unit.

Optionally, when the second communication device uses the AI unit, the first information further includes an applicable condition of the AI unit.

Optionally, when the second communication device uses the AI unit, the receiving module 210 is further configured to receive an applicable condition that is of the AI unit associated with the second identifier and that is sent by the first communication device by using second signaling; or
the sending module is further configured to report the applicable condition of the AI unit to the first communication device based on the second identifier; or the processing module is further configured to perform at least one of the following:
modifying the applicable condition based on the second identifier; or
updating the applicable condition based on the second identifier.

Optionally, the applicable condition of the AI unit includes at least one of the following:
a scenario, a cell, a region, a range, and an access network device;
a hardware configuration, an antenna configuration, and a radio resource configuration; or
a radio environment feature.

The apparatus in this embodiment may be configured to perform the method according to any one of the foregoing method embodiments on the second communication device side. A specific implementation process and technical effects of the apparatus in this embodiment are the same as those in the method embodiments on the second communication device side. For details, reference may be made to the detailed descriptions in the method embodiments on the second communication device side. Details are not described herein.

The apparatus for identifying an AI unit in this embodiment of this application may be an electronic device, for example, an electronic device with an operating system, or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a Network Attached Storage (NAS), or the like. This is not specifically limited in this embodiment of this application.

The apparatus for identifying an AI unit provided in this embodiment of this application can implement various processes implemented in the method embodiments of FIG. 2 to FIG. 4, and achieve a same technical effect. To avoid repetition, details are not described herein again.

Optionally, as shown in FIG. 7, an embodiment of this application further provides a communication device 700, including a processor 701 and a memory 702, and a program or instructions capable of running on the processor 701 are stored in the memory 702. For example, when the communication device 700 is a terminal, the steps of the foregoing embodiment of the method for identifying an AI unit are implemented when the program or the instructions are executed by the processor 701, and a same technical effect can be achieved. When the communication device 700 is a network side device, the program or the instructions are executed by the processor 701 to implement the steps in the foregoing embodiment of the method for identifying an AI unit, and a same technical effect can be achieved. To avoid repetition, details are not described herein again.

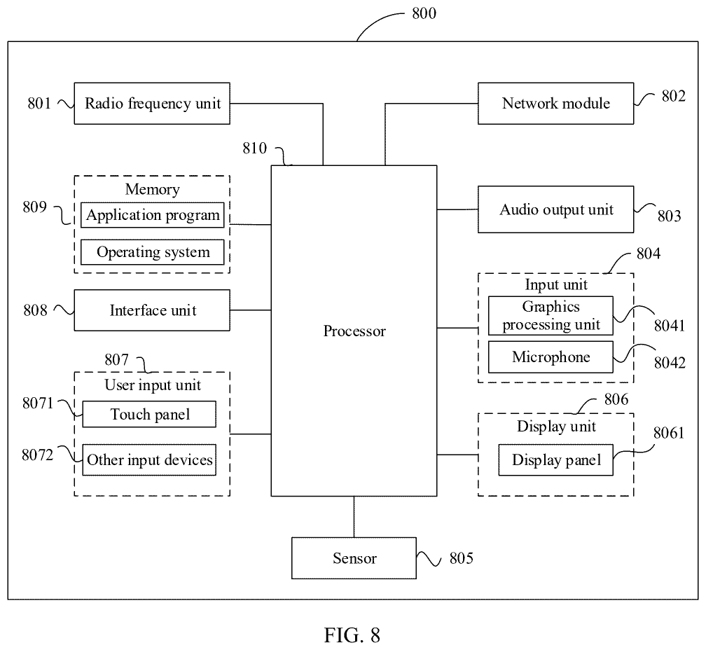

An embodiment of this application further provides a second communication device, including a processor and a communication interface. The communication interface is coupled to the processor. The processor is configured to run a program or instructions to implement the steps in the method embodiment shown in FIG. 4. This embodiment of the second communication device corresponds to the foregoing method embodiment of the second communication device. Each implementation process and implementations of the foregoing method embodiment may be applied to this embodiment of the second communication device, and a same technical effect can be achieved. Optionally, the second communication device is a terminal. Specifically, FIG. 8 is a schematic structural diagram of hardware of a terminal for implementing an embodiment of this application. A terminal 800 includes but is not limited to at least some components in a radio frequency unit 801, a network module 802, an audio output unit 803, an input unit 804, a sensor 805, a display unit 806, a user input unit 807, an interface unit 808, a memory 809, a processor 810, and the like.

A person skilled in the art may understand that the terminal 800 may further include a power supply (for example, a battery) that supplies power to each component. The power supply may be logically connected to the processor 810 by using a power management system, to implement functions such as charging management, discharging management, and power consumption management through the power management system. The structure of the terminal shown in FIG. 8 does not constitute a limitation on the terminal. The terminal may include more or fewer components than those shown in the figure, or combine some components, or have different component arrangements. Details are not described herein again.

It should be understood that in this embodiment of this application, the input unit 804 can include a Graphics Processing Unit (GPU) 8041 and a microphone 8042. The graphics processing unit 8041 processes image data of a still picture or a video obtained by an image capture apparatus (for example, a camera) in a video capture mode or an image capture mode. The display unit 806 can include a display panel 8061, and the display panel 8061 can be configured in a form of a liquid crystal display, an organic light-emitting diode, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but are not limited to a physical keyboard, a function key (such as a volume control key or an on/off key), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low-noise amplifier, a duplexer, and the like.

The memory 809 may be configured to store a software program or instructions and various types of data. The memory 809 may mainly include a first storage area for storing a program or instructions and a second storage area for storing data. The first storage area may store an operating system, an application program or instructions required by at least one function (for example, a sound play function or an image play function), and the like. In addition, the memory 809 may include a volatile memory or a nonvolatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 809 in this embodiment of this application includes but is not limited to these memories and any other suitable type of memory.

The processor 810 may include one or more processing units. Optionally, the processor 810 is integrated with an application processor and a modem processor. The application processor mainly processes operations related to an operating system, a user interface, an application program, and the like. The modem processor mainly processes a wireless communication signal, such as a baseband processor. It may be understood that, the foregoing modem processor may not be integrated into the processor 810.

The radio frequency unit 801 is configured to receive first information that is of an AI unit and that is sent by a first communication device, where the first information includes a first identifier of the AI unit, and the AI unit is associated with a second identifier.

Optionally, the first identifier is used to indicate a first procedure.

The first procedure includes at least one of the following:
storage of the AI unit, transmission of the AI unit, transfer of the AI unit, training of the AI unit, updating of the AI unit, registration of the AI unit, configuration of the AI unit, or identification of the AI unit.

Optionally, the second identifier is used to indicate a second procedure.

The second procedure includes at least one of the following:
activation of the AI unit, deactivation of the AI unit, selection of the AI unit, switching of the AI unit, inference of the AI unit, performance monitoring of the AI unit, performance management of the AI unit, fallback to a non-AI unit, training of the AI unit, updating of the AI unit, registration of the AI unit, configuration of the AI unit, or identification of the AI unit.

Optionally, the first identifier is associated with at least one of the following:
an AI model, a machine learning model, an AI structure, a neural network, a neural network function, and a neural network functionality;
a processing unit for at least one of an algorithm, a formula, a processing procedure, and a capability related to AI; or
a first object running on at least one AI-related hardware in a graphics processing unit GPU, an embedded neural network processing unit NPU, a tensor processing unit TPU, and an application-specific integrated circuit ASIC, where the first object includes at least one of the following: a processing method, an algorithm, a function, a module, or a unit.

Optionally, the second identifier is associated with at least one of the following:
a target dataset associated with the AI unit;
an identifier of a second object associated with the AI unit; or
an identifier of a third object associated with the AI unit; where
the second object includes at least one of the following: a scenario, a cell, a region, a geographical area range, and an access network device; and
the third object includes at least one of the following: a function, a feature, or a configuration.

Optionally, the target dataset includes input data and/or output data of the AI unit, or the target dataset is used to obtain input data and/or output data of the AI unit; and/or
one set in the target dataset includes at least one of the following: at least one piece of input data of the AI unit, at least one piece of output data of the AI unit, or at least one piece of original data, where the original data is used to obtain at least one piece of input data and/or at least one piece of output data of the AI unit.

Optionally, the input data of the AI unit is identical to the output data.

Optionally, the AI unit is obtained after the AI unit is trained based on data collected from the second object; and/or
the AI unit is adapted to the second object, or the AI unit is capable of working normally or achieving normal performance within a coverage range of the second object.

Optionally, a sub-object in the third object includes at least one of the following: a hardware configuration, an antenna configuration, a radio resource configuration, or a radio environment feature.

Optionally, the first information further includes the second identifier of the AI unit; or
the radio frequency unit 801 is further configured to:
receive the second identifier sent by the first communication device by using first signaling, where the first signaling is different from signaling for sending description information of the AI unit.

Optionally, the first information further includes the description information of the AI unit, and the description information of the AI unit includes the second identifier of the AI unit.

Optionally, one second identifier is associated with a plurality of AI units, and the first identifier of each of the plurality of AI units is different.

Optionally, the processor 810 is further configured to:
when an AI unit corresponding to a target first identifier in the plurality of first identifiers meets the second information, use the AI unit corresponding to the target first identifier, where the second information includes at least one of the following: an applicable condition of the AI unit or a key performance indicator KPI, and the second information is configured by the first communication device.

Optionally, one AI unit is associated with a plurality of second identifiers.

Optionally, the first information is used to instruct the second communication device to update the AI unit corresponding to the first identifier; and
the processor 810 is further configured to:
update the AI unit corresponding to the first identifier.

Optionally, the first information includes a parameter of the AI unit, and the first information is used to instruct to update a parameter of the AI unit corresponding to the first identifier; or
the processor 810 is specifically configured to:
update the parameter of the AI unit corresponding to the first identifier.

Optionally, when the AI unit is updated, the second identifier associated with the AI unit remains unchanged, and/or the first identifier of the updated AI unit is different from the first identifier of the unupdated AI unit.

Optionally, the radio frequency unit 801 is further configured to:
when the second communication device uses the AI unit, receive third information sent by the first communication device, where the third information is sent when the first communication device performs at least one of data collection configuration, measurement resource configuration, or reporting resource configuration; or
when the second communication device uses the AI unit, carry the third information when reporting collected data, where the collected data is data that is of a second object corresponding to the third information and that is collected by the second communication device, and/or the collected data is data that is of a sub-object in a third object corresponding to the third information and that is collected by the second communication device, the second object includes at least one of the following: a scenario, a cell, a region, a geographical area range, or an access network device, and the sub-object in the third object includes at least one of the following: a hardware configuration, an antenna configuration, a radio resource configuration, or a radio environment feature; where
the third information includes the second identifier and/or an applicable condition of the AI unit.

Optionally, when the second communication device uses the AI unit, the first information further includes an applicable condition of the AI unit.

Optionally, when the second communication device uses the AI unit, the radio frequency unit 801 is further configured to perform at least one of the following:
receiving an applicable condition that is of the AI unit associated with the second identifier and that is sent by the first communication device by using second signaling; or
reporting the applicable condition of the AI unit to the first communication device based on the second identifier.

The processor 810 is further configured to perform at least one of the following:
modifying the applicable condition based on the second identifier; or
updating the applicable condition based on the second identifier.

Optionally, the applicable condition of the AI unit includes at least one of the following:
a scenario, a cell, a region, a range, and an access network device;
a hardware configuration, an antenna configuration, and a radio resource configuration; or
a radio environment feature.

It may be understood that, for implementation processes of the implementations mentioned in this embodiment, reference may be made to related descriptions in the method embodiment on the second communication device side, and same or corresponding technical effects are achieved. To avoid repetition, details are not described herein again.

An embodiment of this application further provides a first communication device, including a processor and a communication interface. The communication interface is coupled to the processor. The processor is configured to run a program or instructions to implement the steps in the method embodiment shown in FIG. 2. This embodiment of the first communication device corresponds to the foregoing method embodiment of the first communication device. Each implementation process and implementations of the foregoing method embodiment may be applied to this embodiment of the first communication device, and a same technical effect can be achieved.

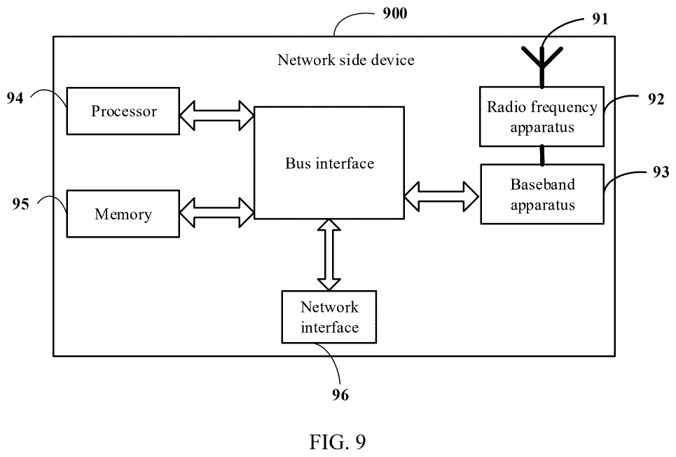

Optionally, the first communication device is a network side device. Specifically, an embodiment of this application further provides a network side device. As shown in FIG. 9, a network side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information through the antenna 91, and sends the received information to the baseband apparatus 93 for processing. In a downlink direction, the baseband apparatus 93 processes to-be-sent information, and sends processed information to the radio frequency apparatus 92. After processing the received information, the radio frequency apparatus 92 sends processed information through the antenna 91.

The method performed by the network side device in the foregoing embodiment may be implemented in the baseband apparatus 93. The baseband apparatus 93 includes a baseband processor.

For example, the baseband apparatus 93 may include at least one baseband board. A plurality of chips are disposed on the baseband board. As shown in FIG. 9, one of the chips is, for example, the baseband processor, and is connected to the memory 95 by using a bus interface, to invoke a program in the memory 95 to perform an operation of a network device shown in the foregoing method embodiment.

The network side device may further include a network interface 96, and the interface is, for example, a common public radio interface (Common Public Radio Interface, CPRI).

Specifically, the network side device 900 in this embodiment of this application further includes instructions or a program stored in the memory 95 and capable of running on the processor 94. The processor 94 invokes the instructions or the program in the memory 95 to perform the method performed by the modules shown in FIG. 5, and a same technical effect is achieved. To avoid repetition, details are not described herein again.

An embodiment of this application further provides a readable storage medium. The readable storage medium stores a program or instructions, the program or instructions are executed by a processor to implement the processes in the foregoing embodiment of the method for identifying an AI unit, and a same technical effect can be achieved. To avoid repetition, details are not described herein again.

The processor is a processor in the terminal in the foregoing embodiment. The readable storage medium includes a computer-readable storage medium, for example, a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, the processor is configured to run a program or instructions to implement the processes in the foregoing embodiment of the method for identifying an AI unit, and a same technical effect can be achieved. To avoid repetition, details are not described herein again.

It should be understood that the chip mentioned in this embodiment of this application can also be referred to as a system-level chip, a system chip, a chip system, a system on chip, or the like.

An embodiment of this application further provides a computer program/program product. The computer program/program product is stored in a storage medium, the computer program/program product is executed by at least one processor to implement the processes in the foregoing embodiment of the method for identifying an AI unit, and a same technical effect can be achieved. To avoid repetition, details are not described herein again.

An embodiment of this application further provides a communication system, including a first communication device and a second communication device. The first communication device may be configured to perform the steps of the foregoing method for identifying an AI unit, and the second communication device may be configured to perform the steps of the foregoing method for identifying an AI unit.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. A method for identifying an Artificial Intelligence (AI) unit, comprising:
obtaining, by a first communication device, a first identifier of the AI unit, wherein the AI unit is associated with a second identifier; and
sending, by the first communication device, first information of the AI unit to a second communication device, wherein the first information comprises the first identifier of the AI unit.

2. The method according to claim 1, wherein:
the first identifier is used to indicate a first procedure; and
the first procedure comprises at least one of the following:
storage of the AI unit, transmission of the AI unit, transfer of the AI unit, training of the AI unit, updating of the AI unit, registration of the AI unit, configuration of the AI unit, or identification of the AI unit.

3. The method according to claim 1, wherein the second identifier is used to indicate a second procedure; and
wherein the second procedure comprises at least one of the following:
activation of the AI unit, deactivation of the AI unit, selection of the AI unit, switching of the AI unit, inference of the AI unit, performance monitoring of the AI unit, performance management of the AI unit, fallback to a non-AI unit, training of the AI unit, updating of the AI unit, registration of the AI unit, configuration of the AI unit, or identification of the AI unit;
or, wherein the second identifier is associated with at least one of the following:
a target dataset associated with the AI unit;
an identifier of a second object associated with the AI unit; or
an identifier of a third object associated with the AI unit; wherein
the second object comprises at least one of the following: a scenario, a cell, a region, a geographical area range, or an access network device; and
the third object comprises at least one of the following: a function, a feature, or a configuration.

4. The method according to claim 1, wherein:
the first identifier is associated with at least one of the following:
an AI model, a machine learning model, an AI structure, a neural network, a neural network function, or a neural network functionality;
a processing unit for at least one of an algorithm, a formula, a processing procedure, and a capability related to AI; and
a first object running on at least one AI-related hardware in a graphics processing unit GPU, an embedded neural network processing unit NPU, a tensor processing unit TPU, and an application-specific integrated circuit ASIC, wherein the first object comprises at least one of the following: a processing method, an algorithm, a function, a module, or a unit.

5. The method according to claim 3, wherein the method comprises at least one of:
the target dataset comprises at least one of input data or output data of the AI unit, or the target dataset is used to obtain input data and/or output data of the AI unit; and/or
one set in the target dataset comprises at least one of the following: at least one piece of input data of the AI unit, at least one piece of output data of the AI unit, or at least one piece of original data, wherein the original data is used to obtain at least one of: at least one piece of input data or at least one piece of output data of the AI unit.

6. The method according to claim 5, wherein the input data of the AI unit is identical to the output data.

7. The method according to claim 3, wherein
the AI unit is obtained after the AI unit is trained based on data collected from the second object; and/or
the AI unit is adapted to the second object, or the AI unit is capable of working normally or achieving normal performance within a coverage range of the second object.

8. The method according to claim 1, wherein
the first communication device is a network side device, and the second communication device is a terminal.

9. The method according to claim 1, wherein the method further comprises:
when the second communication device uses the AI unit, performing, by the first communication device, lifecycle management of the second procedure for the AI unit by using the second identifier of the AI unit;
or, wherein the method further comprises:
performing, by the first communication device, first processing based on an original AI unit corresponding to the second identifier, to obtain a plurality of AI units, wherein the first identifier of each of the plurality of AI units is different.

10. The method according to claim 9, wherein the method further comprises:
configuring, by the first communication device, second information associated with a plurality of first identifiers; wherein
when an AI unit corresponding to a target first identifier in the plurality of first identifiers meets the second information, the AI unit corresponding to the target first identifier is capable of being used by the second communication device, and the second information comprises at least one of the following: an applicable condition or a key performance indicator KPI.

11. The method according to claim 1, wherein the AI unit is associated with a plurality of second identifiers.

12. The method according to claim 1, wherein:
the first information is used to instruct the second communication device to update the AI unit corresponding to the first identifier; or
the method further comprises:
updating, by the first communication device, the AI unit corresponding to the first identifier.

13. The method according to claim 12, wherein:
the first information comprises a parameter of the AI unit, and the first information is used to instruct to update a parameter of the AI unit corresponding to the first identifier; and
the updating, by the first communication device, the AI unit corresponding to the first identifier comprises:
updating, by the first communication device, the parameter of the AI unit corresponding to the first identifier.

14. The method according to claim 12, wherein:
when the AI unit is updated, the second identifier associated with the AI unit remains unchanged, and/or the first identifier of the updated AI unit is different from the first identifier of the unupdated AI unit.

15. The method according to claim 1, wherein the method further comprises:
when the second communication device uses the AI unit, indicating or carrying, by the first communication device, third information when the first communication device performs at least one of data collection configuration, measurement resource configuration, or reporting resource configuration; and
when the second communication device uses the AI unit, receiving, by the first communication device, the third information carried when the second communication device reports collected data, wherein the collected data is data that is of a second object corresponding to the third information and that is collected by the second communication device, and/or the collected data is data that is of a sub-object in a third object corresponding to the third information and that is collected by the second communication device, the second object comprises at least one of the following: a scenario, a cell, a region, a geographical area range, and an access network device, or the sub-object in the third object comprises at least one of the following: a hardware configuration, an antenna configuration, a radio resource configuration, or a radio environment feature; wherein
the third information comprises at least one of the second identifier or an applicable condition of the AI unit.

16. The method according to claim 15, wherein the method further comprises at least one of the following:
when a current condition does not meet the applicable condition of the AI unit, performing, by the first communication device, second processing, wherein the second processing comprises at least one of the following: switching of the AI unit, deactivation of the AI unit, selection of a new AI unit, performance monitoring, performance monitoring reporting, or data collection; or
when an applicable condition of a target AI unit meets the current condition, performing, by the first communication device, third processing, wherein the third processing comprises at least one of the following: switching of the AI unit, activation of the target AI unit, performance monitoring, performance monitoring reporting, or data collection.

17. The method according to claim 1, wherein the method further comprises at least one of the following:
when the second communication device uses the AI unit, the first information further comprising an applicable condition of the AI unit;
when the second communication device uses the AI unit, indicating, by the first communication device to the second communication device by using second signaling, an applicable condition of the AI unit associated with the second identifier;
receiving, by the first communication device, an applicable condition of the AI unit that is reported by the second communication device based on the second identifier;
modifying, by the first communication device, an applicable condition based on the second identifier; or
updating, by the first communication device, an applicable condition based on the second identifier.

18. A method for identifying an Artificial Intelligence (AI) unit, comprising:
receiving, by a second communication device, first information of the AI unit that is sent by a first communication device, wherein the first information comprises a first identifier of the AI unit, and the AI unit is associated with a second identifier.

19. The second communication device, comprising a processor and a memory, wherein the memory stores a program or instructions capable of running on the processor, and the program or the instructions are executed by the processor to implement the method according to claim 18.

20. A first communication device, comprising a processor and a memory, wherein the memory stores a program or instructions capable of running on the processor, and the program or the instructions are executed by the processor to:
obtain a first identifier of an AI unit, wherein the AI unit is associated with a second identifier, and
send first information of the AI unit to a second communication device, wherein the first information comprises the first identifier of the AI unit.
